(19) United States
(12) Patent Application Publication
(10) Pub. No.: US 2005/0119913 A1
(43) Pub. Date: Jun. 2, 2005

(54) Subscription-based dynamic content update

(75) Inventors: Harry Hornreich, Rehovot (IL); Shiri Lupovici, Modi'in (IL); Yafit Sami, Rishon Lezion (IL); Marjorie Schejter, Rehovot (IL); Haim Schneider, Ramot Meir (IL)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/724,931

(22) Filed: Dec. 1, 2003

(51) Int. Cl. G06F 17/60

(52) U.S. Cl. 705/2

(57) ABSTRACT

A subscription-based dynamic content update system including a content update sub-system including a session manager operative to associate a web page currently active at a client and having at least one specialized content area with a subscription for content therefor, a subscription manager operative to create the subscription on a publish/subscribe server, an event buffer operative to store a content update received from the publish/subscribe server in response to a publication received from a content provider and in connection with the subscription, and a monitor operative to receive the content update from the content update sub-system and provide the content update for updating the specialized content area.

### FIELD OF THE INVENTION

The present invention relates to client-server technology in general, and in particular to subscription-based dynamic content update, such as of web portals.

### BACKGROUND OF THE INVENTION

The Internet-based World Wide Web has evolved from a distributed file system in which users could request delivery of already-generated static documents, to a system in which dynamic and personalized content is generated in real time and served to users. One area of increasing popularity where this trend is evident is in content frameworks such as those commonly referred to as “portals.” A portal is typically designed to serve as a gateway, or focal point, through which users access information and applications from many different sources. A portal web page typically includes multiple “portlets” which are specialized content areas that occupy small defined windows within the portal page. For example, one portlet might contain a travel itinerary, while another portlet contains sports scores. The content, appearance, and position of a portlet may be personalized for each particular user.

While a portal page and the portlets it contains may be dynamically generated in response to a user accessing the portal, once the user receives the portal page the information it contains is not typically updated automatically. Thus, for example, a user who views a portal page and wishes to know after several minutes if the sports scores he is viewing have changed, must manually reload the portal page in order to get the updated information.

While some portals automatically refresh the portal page periodically, this approach has several drawbacks. These include putting a heavy load on the portal server which must repeatedly perform data retrieval and rendering for each portlet, and disrupting the user's viewing experience as the whole portal page keeps refreshing while the user is watching it, even if no content has changed.

Some portals are designed such that their portal pages cause the user's client computer to periodically poll the portal server in order to check for updates, with the client requesting an updated version of the portal page only when new information is available. This technique is effective when the test for the presence of new information is simple. For example, in a public auction the polling might request the time of the latest bid for a certain item currently displayed at the client and then compare the polled time with the time of the displayed bid. However, this technique has several drawbacks when applied to a portal environment, since the content of the portlet is often the result of a complex query that is customized for the user. Thus polling would require performing a user-customized query for each portlet, placing a heavy burden on the portal server. Furthermore, there is no simple or standard way to compare the results of a query to existing portlet content in order to determine that the content has changed.

An improved approach for updating web page content, and particularly user-customized portlet content, would therefore be advantageous.

### SUMMARY OF THE INVENTION

The present invention provides an improved approach for updating web page content, such as portlet content, whereby a publish/subscribe mechanism is used to identify content updates and provide notifications of such updates to a server. A web-page based monitor at the client periodically polls or otherwise monitors the server for content update notifications and automatically retrieves content updates which are then displayed within the web page. Thus, a web page is only updated if its underlying content has changed, the server does not need to perform complex user-customized queries in response to client polling, and the user does not need to manually reload the web page.

In one aspect of the present invention a subscription-based dynamic content update system is provided including a content update sub-system including a session manager operative to associate a web page currently active at a client and having at least one specialized content area with a subscription for content therefor, a subscription manager operative to create the subscription on a publish/subscribe server, an event buffer operative to store a content update received from the publish/subscribe server in response to a publication received from a content provider and in connection with the subscription, and a monitor operative to receive the content update from the content update sub-system and provide the content update for updating the specialized content area.

In another aspect of the present invention the system further includes a server operative to host a web site including at least one software component for dynamically generating the specialized content area of the web page, and provide the web page for display on a client computer.

In another aspect of the present invention the server is a portal server and where the web site is a portal.

In another aspect of the present invention the software component is a portlet.

In another aspect of the present invention the monitor maintains a persistent connection with the content update sub-system through which the monitor receives the content update.

In another aspect of the present invention the monitor periodically polls the content update sub-system for the existence of the content update.

In another aspect of the present invention a method for subscription-based dynamic content updating is provided, the method including associating a web page currently active at a client and having at least one specialized content area with a subscription for content therefor, receiving a content update from a content provider in connection with the subscription, and providing the content update for updating the specialized content area.

In another aspect of the present invention the method further includes creating the subscription on a publish/subscribe server, and storing the content update received from the publish/subscribe server in response to a publication received from the content provider and in connection with the subscription.

In another aspect of the present invention the method further includes dynamically generating the web page including the specialized content area, and providing the web page and the monitor to a client computer.

In another aspect of the present invention a computer program is provided embodied on a computer-readable medium, the computer program including a first code segment operative to associate a web page currently active at a client and having at least one specialized content area with a subscription for content therefor, a second code segment operative to receive a content update from a content provider in connection with the subscription, and a third code segment operative to provide the content update for updating the specialized content area.

In another aspect of the present invention the computer program further includes a fourth code segment operative to create the subscription on a publish/subscribe server, and a fifth code segment operative to store the content update received from the publish/subscribe server in response to a publication received from the content provider and in connection with the subscription.

### BRIEF DESCRIPTION OF THE DRAWINGS

The present invention will be understood and appreciated more fully from the following detailed description taken in conjunction with the appended drawings in which:

FIG. 1 is a simplified block-flow diagram of a subscription-based dynamic content update system, constructed and operative in accordance with a preferred embodiment of the present invention; and

FIG. 2 is a simplified flowchart illustration of an exemplary method of operation of the subscription-based dynamic content update system of FIG. 1.

### DETAILED DESCRIPTION OF PREFERRED EMBODIMENTS

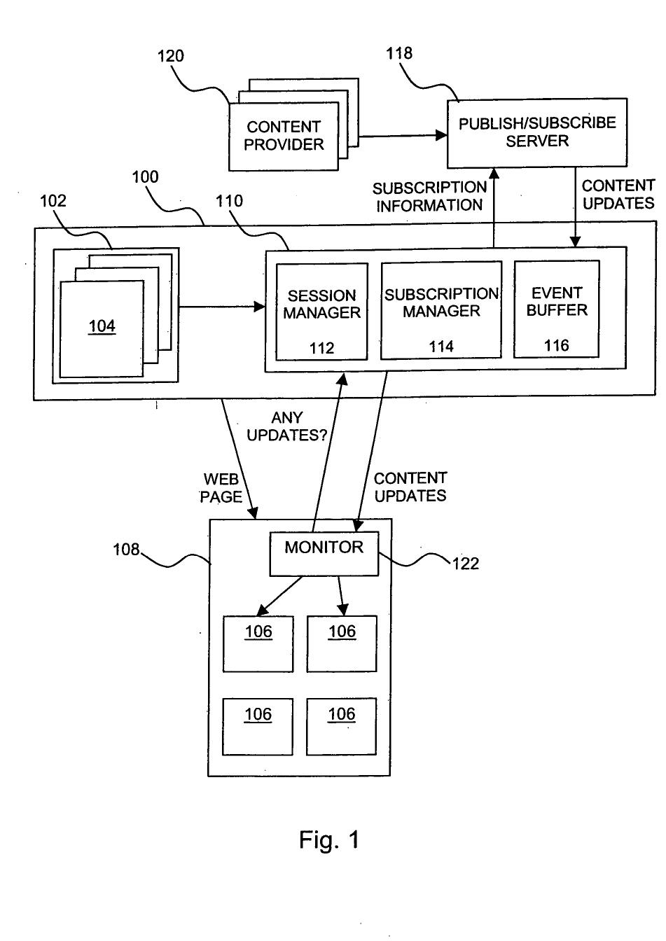

Reference is now made to FIG. 1, which is a simplified block-flow diagram of a subscription-based dynamic content update system, constructed and operative in accordance with a preferred embodiment of the present invention. In the system of FIG. 1 a server 100, such as a portal server, hosts a web site 102, such as a portal. Web site 102 includes one or more software components 104, such as portlets, for dynamically generating specialized content areas 106 of a web page 108 that is provided to a client computer, such as for display. Software components 104 also preferably generate subscriptions for content for one or more of specialized content areas 106. Server 100 also includes a content update sub-system 110 which preferably includes a session manager 112, a subscription manager 114, and an event buffer 116. Session manager 112 associates an instance of a web page currently displayed or otherwise active on a client with the set of subscriptions for content generated therefor. Subscription manager 114 creates and removes subscriptions for content on a publish/subscribe server 118, such as an IBM MQ Series or any other message-oriented middleware system that provides publish/subscribe services. Event buffer 116 stores content updates that are received from publish/subscribe server 118 in response to publications received from one or more content providers 120 and in connection with subscriptions. Web page 108 preferably includes a monitor 122 that periodically polls sub-system 110 for the existence of content updates with respect to specialized content areas 106, and provides the content updates to specialized content areas 106. Alternatively, monitor 122 maintains a persistent connection with sub-system 110 through which monitor 122 receives content updates as they arrive from the publish/subscribe server.

The subscription is preferably defined such that it identifies any change to the source of the content that is displayed by the user-customized portlet and that would cause the portlet to display different content if it were refreshed. For example, a user who is interested in financial news relating to IBM may access a portal web page that includes a user-customized portlet that displays such news. A subscription for financial news relating to IBM would then be established for the user-customized portlet. When a new news item that matches the subscription criteria is published it is sent to the user as a content update and the portlet is refreshed, causing the updated content to be displayed.

A content update may be represented in a text format that the portlet can parse, and from which the portlet can extract information for refreshing the content. For example, the content update may be in Extensible Markup Language (XML) format that may include hypertext links, such as to a new news item. Specifically, the Rich Site Summary (RSS) format of XML may be used for representing news headlines, including a news header, a publication time, and a link to the news item. The portlet may be configured to parse the RSS message using conventional techniques, extract information for display, and use Dynamic Hypertext Markup Language (DHTML) to add the new item to its current display of latest news.

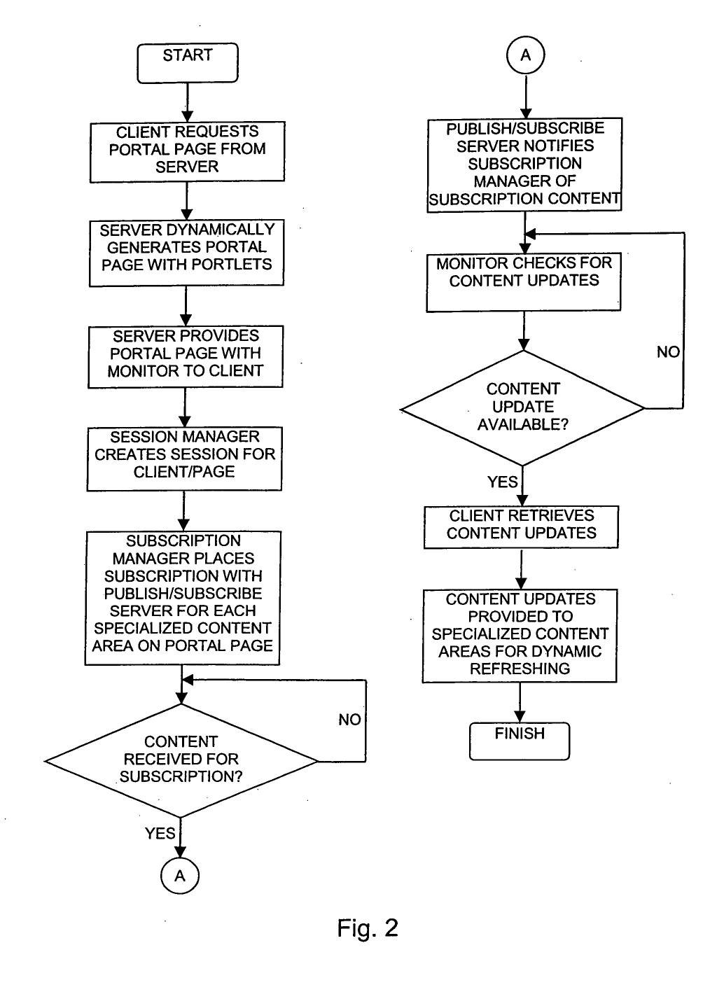

Reference is now made to FIG. 2, which is a simplified flowchart illustration of an exemplary method of operation of the subscription-based dynamic content update system of FIG. 1, operative in accordance with a preferred embodiment of the present invention. In the method of FIG. 2, which is described with respect to a web portal for illustration only, when a client requests a portal page, portal server 100 dynamically creates portal page 108, where specialized content areas 106 are generated using content provided by server-side portlets 104. Server 100 also generates subscriptions for content for specialized content areas 106 as required. Server 100 then provides portal page 108 together with monitor 122 to the client, and session manager 112 creates a session associated with the generated portal page and its set of subscriptions. For each specialized content area 106 that requires dynamic content updates, subscription manager 114 places a subscription for content updates with publish/subscribe server 118. Typically, the subscription remains active as long as session manager 112 determines that the related specialized content area 106 is active (e.g., displayed) at the client. Publish/subscribe server 118 matches published content received from content providers 120 with the subscriptions. When a match is identified, publish/subscribe server 118 notifies subscription manager 114, and the updated content is stored in event buffer 116. Monitor 122 periodically polls sub-system 110 for the existence of content updates and retrieves any content updates from event buffer 116. Alternatively, monitor 122 maintains a persistent connection with sub-system 110 through which monitor 122 receives content updates as they arrive from the publish/subscribe server. Monitor 122 provides content updates to the relevant specialized content areas 106, which may be client-side portlets capable of being called by monitor 122 to dynamically refresh its portion of the page, such as by using dynamic HTML.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques. Thus, for example, client-side components described hereinabove may be implemented using the Extensible Markup Language (XML), Hypertext Markup Language (HTML), JavaScript™, Java Applets, ActiveX™, or any combination thereof.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A subscription-based dynamic content update system comprising:
a content update sub-system comprising:
a session manager operative to associate a web page currently active at a client and having at least one specialized content area with a subscription for content therefor;
a subscription manager operative to create said subscription on a publish/subscribe server;
an event buffer operative to store a content update received from said publish/subscribe server in response to a publication received from a content provider and in connection with said subscription; and
a monitor operative to receive said content update from said content update sub-system and provide said content update for updating said specialized content area.

2. A system according to claim 1 and further comprising a server operative to:
host a web site including at least one software component for dynamically generating said specialized content area of said web page, and
provide said web page for display on a client computer.

3. A system according to claim 2 wherein said server is a portal server and wherein said web site is a portal.

4. A system according to claim 2 wherein said software component is a portlet.

5. A system according to claim 1 wherein said monitor maintains a persistent connection with said content update sub-system through which said monitor receives said content update.

6. A system according to claim 1 wherein said monitor periodically polls said content update sub-system for the existence of said content update.

7. A method for subscription-based dynamic content updating, the method comprising:
associating a web page currently active at a client and having at least one specialized content area with a subscription for content therefor;
receiving a content update from a content provider in connection with said subscription; and
providing said content update for updating said specialized content area.

8. A method according to claim 7 and further comprising:
creating said subscription on a publish/subscribe server; and
storing said content update received from said publish/subscribe server in response to a publication received from said content provider and in connection with said subscription.

9. A method according to claim 7 and further comprising:
dynamically generating said web page including said specialized content area; and
providing said web page and said monitor to a client computer.

10. A computer program embodied on a computer-readable medium, the computer program comprising:
a first code segment operative to associate a web page currently active at a client and having at least one specialized content area with a subscription for content therefor;
a second code segment operative to receive a content update from a content provider in connection with said subscription; and
a third code segment operative to provide said content update for updating said specialized content area.

11. A computer program according to claim 10 and further comprising:
a fourth code segment operative to create said subscription on a publish/subscribe server; and
a fifth code segment operative to store said content update received from said publish/subscribe server in response to a publication received from said content provider and in connection with said subscription.
